(19) United States
(12) Patent Application Publication
(10) Pub. No.: US 2020/0182433 A1
(43) Pub. Date: Jun. 11, 2020

(54) HEATSINK APPARATUS FOR USE WITH VEHICLE LAMPS

(71) Applicant: VALEO NORTH AMERICA, INC., Troy, MI (US)

(72) Inventors: Julien Hemon, Seymour, IN (US); Guillaume Audrain, Seymour, IN (US)

(73) Assignee: VALEO NORTH AMERICA, INC., Tory, MI (US)

(21) Appl. No.: 16/213,704

(22) Filed: Dec. 7, 2018

(51) Int. Cl. F21S 45/47; F21S 45/50; F21S 41/19; F21S 43/19

(52) U.S. Cl. CPC F21S 45/47; F21S 43/19; F21S 41/198; F21S 45/50

(57) ABSTRACT

Heatsink apparatus for use with vehicle lamps are disclosed. A heatsink assembly for a vehicle lamp includes a circuit board. The heatsink assembly also includes a heatsink configured to couple to the vehicle lamp and defining a mounting portion to receive the circuit board. The heatsink assembly also includes a seal coupled to the heatsink near the mounting portion and including a body configured to form a fluid seal between the heatsink and the vehicle lamp. The body of the seal includes a clip that extends away therefrom past the mounting portion and is configured to couple the circuit board to the heatsink when the circuit board is positioned on the mounting portion.

### FIELD OF THE DISCLOSURE

This disclosure relates generally to vehicle lighting and, more particularly, to heatsink apparatus for use with vehicle lamps.

### BACKGROUND

Motor vehicles typically have lighting devices for both interior and exterior illumination. Some vehicles have exterior lamps (e.g., headlamps, tail lamps, etc.) that employ heatsinks to absorb and/or dissipate heat of the lamps. Such heatsinks are typically coupled to a lamp housing and have fins configured to transfer heat away therefrom to an outside environment, thereby reducing and/or maintaining a temperature of a vehicle lamp.

### SUMMARY

An aspect of the present disclosure includes a heatsink assembly for a vehicle lamp. The heatsink assembly includes a circuit board. The heatsink assembly also includes a heatsink configured to couple to the vehicle lamp and defining a mounting portion to receive the circuit board. The heatsink assembly also includes a seal coupled to the heatsink near the mounting portion and including a body configured to form a fluid seal between the heatsink and the vehicle lamp. The body of the seal includes a clip that extends away therefrom past the mounting portion and is configured to couple the circuit board to the heatsink when the circuit board is positioned on the mounting portion.

In a further aspect of the present disclosure, the clip is configured to move in response to the circuit board moving past the clip toward the mounting portion. The clip is to impart a force on the circuit board to urge the circuit board into engagement with the mounting portion.

In a further aspect of the present disclosure, the heatsink includes an abutment coupled thereto and extending away from the mounting portion to receive the clip. The abutment is to impart a force on the clip to limit movement of the clip away from the circuit board.

In a further aspect of the present disclosure, the abutment includes first and second portions that are positioned on the heat sink proximate to the mounting portion and spaced from each other. The first and second portions are to engage respective first and second arms of the clip that extend away from a central portion of the clip in opposite directions.

In a further aspect of the present disclosure, the clip is at least partially positioned between the first and second portions of the abutment.

In a further aspect of the present disclosure, the heatsink defines a slot in which a tab of the seal is positioned. The tab is to engage an inner surface defined by the slot to limit movement of the clip away from the circuit board.

In a further aspect of the present disclosure, the clip is positioned on the tab.

In a further aspect of the present disclosure, the clip includes two angled surfaces that form an edge and are configured to receive a side of the circuit board.

In a further aspect of the present disclosure, the clip includes an area formed by the two angled surfaces that is configured to compress and decompress in response to the circuit board contacting the area.

In a further aspect of the present disclosure, the clip is a first clip and the body of the seal includes a second clip extending away therefrom and configured to couple the circuit board to the heatsink. The first and second clips are positioned on opposite sides of the circuit board.

In a further aspect of the present disclosure, the first and second clips include a flexible material.

Another aspect of the present disclosure includes a vehicle lamp. The vehicle lamp includes a heatsink coupled to a housing of the vehicle lamp and defining one or more fins to transfer heat away from the vehicle lamp. The vehicle lamp also includes a circuit board positioned on the heatsink. The vehicle lamp also includes a seal defining a body interposed between the heatsink and the housing to prevent fluid from leaking into or out of the housing. The seal includes a first protrusion that is positioned on the body and extends over the circuit board. The first protrusion urges the circuit board into engagement with the heatsink.

In a further aspect of the present disclosure, the first protrusion of the seal abuts one or more surfaces of the heatsink to maintain a force that the protrusion imparts on the circuit board.

In a further aspect of the present disclosure, the heatsink includes second and third protrusions positioned proximate to and extending along an axis of the first protrusion. The second and third protrusions define the one or more surfaces of the heatsink.

In a further aspect of the present disclosure, the first protrusion of the seal defines first and second portions extending away from each other. Each of the second and third protrusions of the heatsink is to impart a force on a respective one of the first and second portions of the first protrusion.

In a further aspect of the present disclosure, the first protrusion of the seal is positioned between the second and third protrusions of the heatsink.

In a further aspect of the present disclosure, a portion of the first protrusion extends into a slot positioned on a wall of the heatsink. The slot defines the one or more surfaces of the heat sink.

In a further aspect of the present disclosure, the heatsink includes a recessed area extending from an outer surface of the heatsink to the slot to expose a portion of the slot. The first protrusion is positioned in the recessed area.

In a further aspect of the present disclosure, the body of the seal surrounds a curved wall of the heat sink.

Another aspect of the present disclosure includes a vehicle. The vehicle includes a heatsink coupled to a lamp of the vehicle and including a circuit board positioned thereon. The vehicle also includes a seal coupled to the heatsink and interposed between a surface of the lamp and a surface of the heatsink to seal a cavity of the lamp. The seal includes means for coupling the circuit board to the heatsink.

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic illustration of an example vehicle in which examples disclosed herein can be implemented;

FIG. 2 is a view of an example vehicle lighting device in which examples disclosed herein can be implemented;

FIG. 3 is a view of an example heatsink assembly in accordance with the teachings of this disclosure;

FIGS. 4-6 are enlarged portion-views of the example heatsink assembly of FIG. 3 and show an example seal protrusion in accordance with the teachings of this disclosure;

FIG. 7 is a detailed view of an example heatsink of the example heatsink assembly of FIG. 3; and

FIG. 8 is a detailed view of an example seal of the example heatsink assembly of FIG. 3.

The figures are not to scale. In general, the same reference numbers will be used throughout the drawing(s) and accompanying written description to refer to the same or like parts.

### DETAILED DESCRIPTION

Some known heatsinks for vehicle lamps are configured to carry a printed circuit board (PCB) that facilitates lighting functionality of the lamps. Such known heatsinks require fasteners (e.g., screws) to couple the PCB thereto. For example, to assemble the PCB and one of these known heatsinks, the PCB is positioned on the heatsink, and then the fasteners are inserted into the PCB and the heatsink to maintain a position of the PCB relative to the heatsink. However, assembling these known heatsinks and PCBs together in this known manner increases costs and/or production time.

Heatsink apparatus for use with vehicle lamps are disclosed. Examples disclosed herein provide an example heatsink assembly including example heatsink and an example seal coupled to the heatsink. The disclosed heatsink is configured to receive and/or carry example an example circuit board (e.g., a PCB) and couple to a portion of a vehicle lamp (e.g., a headlamp) to cool the lamp and/or the circuit board. The disclosed seal is configured to form a fluid seal between the heatsink and the lamp to prevent fluid (e.g., water) and/or other matter from entering or exiting the lamp. In particular, the disclosed seal includes one or more example connection and/or snapping features that are configured to couple (e.g., via a snap-fitting method or technique) the circuit board to the heatsink without any additional fasteners, which would have otherwise been unattainable using the above-mentioned known heatsinks. That is, the disclosed seal includes holding or coupling functionality for the circuit board integrated thereto.

In some disclosed examples, the seal includes one or more example clips that are coupled to a body of the seal and extend away from the body to receive the circuit board. In such examples, the clip(s) are constructed of a flexible material (e.g., silicon), which enables the clip(s) to flex, strain, bend, deform, compress, decompress, and/or otherwise sufficiently move when assembling the heatsink and the circuit board together. For example, as the circuit board is placed on the heatsink, each of the clip(s) includes at least a portion that is configured to compress and/or bend in a first direction to allow the circuit board to pass across the clip(s) and reach a mounting surface of the heatsink. Then, the clip portion(s) decompress and/or bend in a second direction, opposite the first direction, to impart a force or a pressure on a portion (e.g., a topmost surface) of the circuit board, thereby urging the circuit board into engagement with the heatsink and/or maintaining a position of the circuit board relative to the heatsink. Thus, the disclosed seal is able to sufficiently hold the circuit board in place on the heatsink and/or otherwise secure the circuit board. As a result, disclosed examples reduce costs and/or production time associated with the above-mentioned known heatsinks and/or related coupling methods.

Additionally, in some examples, the disclosed heatsink includes one or more example abutments coupled thereto that extend away from the mounting surface to receive respective arms of the clip(s), which improves the coupling functionality of the seal clip(s). In such examples, each of the abutment(s) impart a force or pressure on the respective arms, thereby causing the clip(s) to maintain the force or pressure imparted on the circuit board and/or otherwise limiting movement of the clip(s) away from the circuit board in a third direction (e.g., a horizontal direction) when the circuit board is mounted on the heatsink. Additionally, in some examples, to further improve the coupling functionality of the seal clip(s), the heatsink includes one or more slots extending into a heatsink wall that at least partially defines the mounting portion, each of which corresponds to and/or is associated with a respective one of the clip(s). In such examples, the slot(s) receive tab(s) of the respective clip(s) such that each tab extends into a respective one of the slot(s). As a result, surface(s) defined by the slot(s) impart a force or pressure on the clip tab(s), which further maintains the force or pressure imparted on the circuit board by the clip(s) and/or otherwise further limits movement of the clip(s) away from the circuit board in a fourth direction (e.g., a vertical direction), different from the third direction, when the circuit board is mounted on the heatsink.

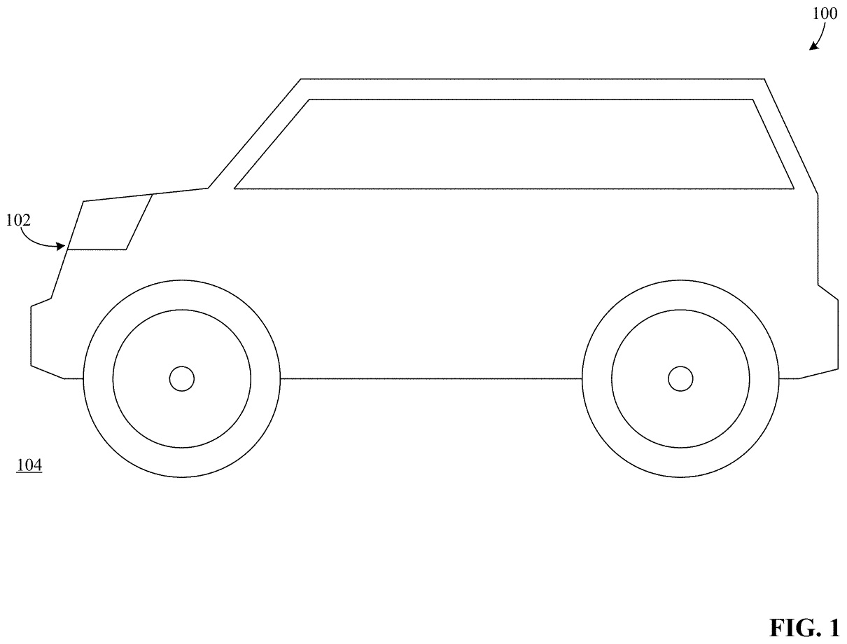

FIG. 1 is a schematic illustration of an example vehicle (e.g., a car, a truck, a sport utility vehicle (SUV), etc.) 100 in which examples disclosed herein can be implemented. According to the illustrated example of FIG. 1, the vehicle 100 includes one or more example lighting devices 102 (one of which is shown in this example) such as, for example, one or more headlamps (sometimes referred to as headlights), one or more tail lamps (sometimes referred to as tail lights), one or more side markers, etc. In particular, the lighting device(s) 102 of FIG. 1 generate light and emit the light away from the vehicle 100, for example, to illuminate an example driving surface (e.g., concrete, asphalt, dirt, etc.) 104 on which the vehicle 100 is positioned and/or provide visual indication(s) to another vehicle and/or a pedestrian. As such, the lighting device(s) 102 are operatively and/or communicatively couple (e.g., via a transmission or signal wire, a bus, radio frequency, etc.) to one or more electrical components and/or circuitry to enable lighting functionality such as, for example, a controller (e.g., an electronic control unit (ECU)) of the vehicle 100. For example, the lighting device(s) 102 receive power and/or control or command signal(s) from the vehicle controller, thereby generating the light. Although FIG. 1 depicts the vehicle 100 as having a single headlamp, in some examples, the vehicle 100 is implemented differently (e.g., having one or more additional and/or different lighting devices).

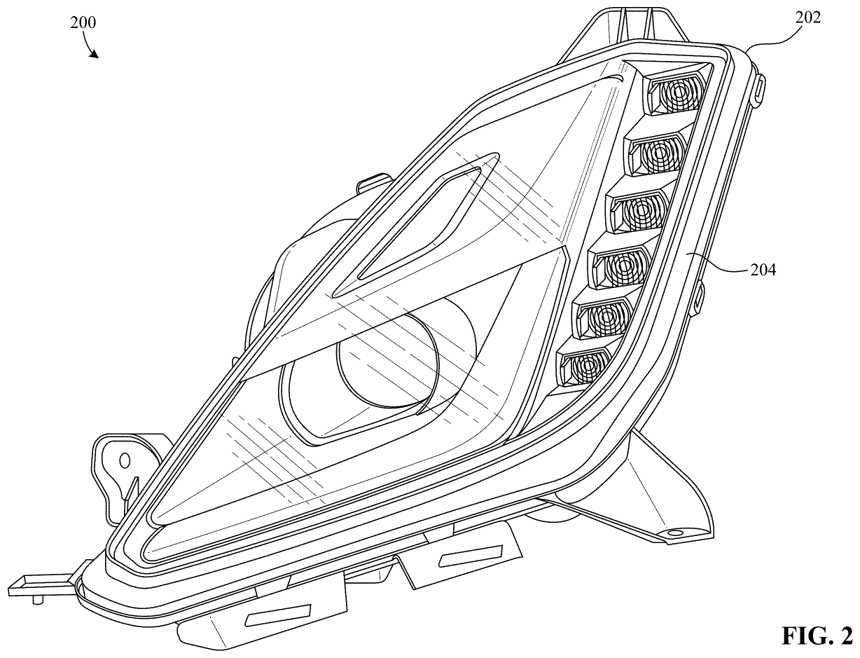

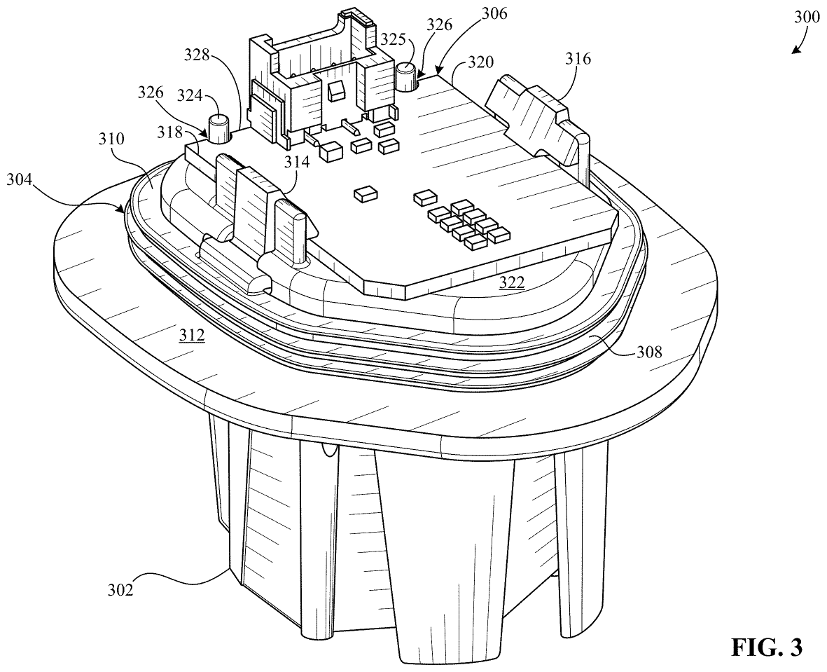

FIG. 2 is a detailed view of an example lighting device (e.g., a vehicle lamp such as a headlamp) 200 in which examples disclosed herein can be implemented. In some examples, the lighting device 200 corresponds to one or more of the vehicle lighting device(s) 102 of FIG. 1. In particular, the lighting device 200 is configured generate light (e.g., one or more beams) and emit the light away therefrom. The lighting device 200 of FIG. 2 includes an example housing 202 that is sized, shaped, structured, and/or otherwise configured to support and/or carry one or more components (e.g., functional component(s) and/or non-functional component(s)) associated with the lighting device 200 such as, for example, a bezel, one or more reflectors, one or more lenses, one or more light sources, one or more cables or wires for providing power and/or communication, etc. Additionally, the housing 202 may define a cavity in which one or more of the component(s) are positioned. In some examples, the housing 202 includes a surface (e.g., an outer surface) 204 that defines at least an opening (e.g., extending through the housing 202 to the cavity) that is configured to receive a portion of a heatsink (e.g., a portion of the heatsink 302 of FIG. 3), which is discussed further below.

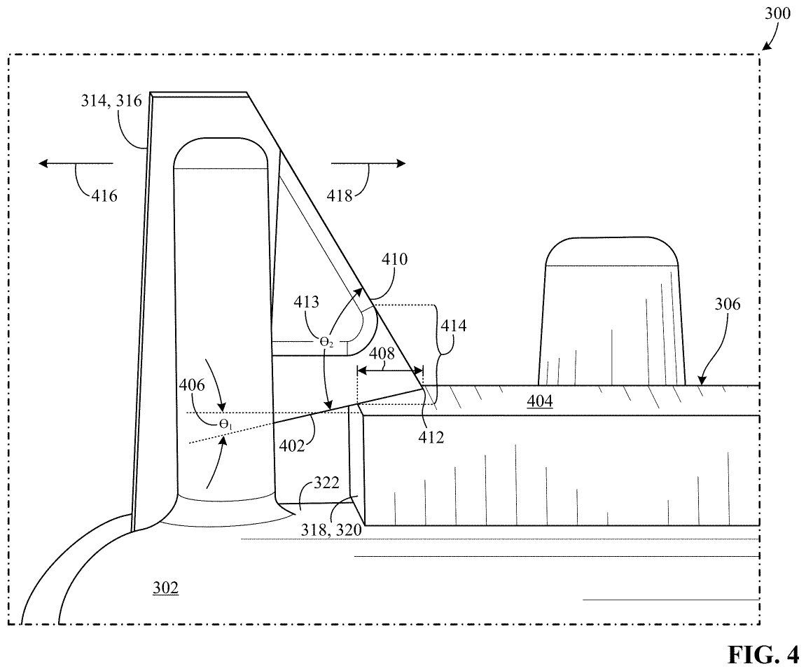

FIG. 3 is a view of an example heatsink assembly 300 in accordance with the teachings of this disclosure. According to the illustrated example of FIG. 3, the heatsink assembly 300 includes an example heatsink 302, an example seal 304, and an example circuit board 306. The heatsink assembly 300 of FIG. 3 is configured to reduce and/or maintain a temperature of the light device 200 of FIG. 2 and/or the circuit board 306 by transferring heat away therefrom (i.e., dissipating the heat). In particular, the seal 304 of FIG. 3 is sized, shaped, structured, and/or otherwise configured to couple (e.g., removably couple) the circuit board 306 to the heatsink 302 without additional fastener(s) (e.g., screw(s), adhesive(s), etc.) or fastening method(s) (e.g., welding), as discussed below in connection with FIGS. 4-8.

The heatsink 302 of FIG. 3 is configured to couple (e.g., removably couple) to a portion of the lighting device 200 (e.g., the housing 202), for example, via one or more example fasteners (e.g., screw(s), bolt(s), adhesive(s), etc.) and/or one or more example fastening methods or techniques (e.g., via welding, snap-fitting, etc.). For example, when installed, a portion of the heatsink 302 and/or the circuit board 306 is/are positioned in the aforementioned opening and/or the cavity of the housing 202. In particular, when the heatsink 302 is properly affixed to and/or positioned on the housing 202, a body 308 of the seal 304 sealingly engages the heatsink 302 and the housing 202, thereby preventing fluid(s) (e.g., water) and/or other matter from entering or exiting the housing 202, which protects the circuit board 306 and/or one or more other components of the lighting device 200. That is, a surface (e.g., an outer surface) 310 of the body 308 directly contacts a surface (e.g., an outer surface) 312 of the heatsink 302 and a portion of the housing surface 204 surrounding and/or proximate to the opening of the housing 202 to define a fluid seal or barrier. Stated differently, the seal body 308 is interposed and/or coupled between the heatsink 302 and the lighting device 200 to seal the lighting device 200 (i.e., seal the housing opening and/or the housing cavity). In this manner, the seal 304 substantially isolates an interior of the lighting device 200 from an outside environment.

The seal 304 of FIG. 3 is coupled to the heatsink 302, for example, via the one or more example fasteners and/or fastening methods or techniques. In particular, the seal 304 includes one or more example protrusions (e.g., one or more clips) 314, 316 for coupling the circuit board 306 to the heatsink 302, two of which are shown in this example (i.e., a first example protrusion (e.g. a first clip) 314 and a second example protrusion (e.g., a second clip) 316). As shown in FIG. 3, the first and second seal protrusions 314, 316 are positioned on opposing sides of the circuit board 306 such that the circuit board 306 is interposed between the first and second protrusions 314, 316, which better maintains a position and/or an orientation of the circuit board 306 relative to the heatsink 302 compared to using a single seal protrusion. That is, the first protrusion 314 is positioned near a first side 318 of the circuit board 306, and the second protrusion 316 is positioned near a second side 320 of the circuit board 306 opposite the first side 318. Although FIG. 3 depicts the two protrusions 314, 316, in some examples, the seal 304 is implemented using a single protrusion or additional protrusions.

The circuit board 306 of FIG. 3 can be implemented, for example, using a PCB having one or more layers and/or appropriate circuitry coupled thereto. In some examples, the circuit board 306 corresponds to the ECU of the vehicle 100. The circuit board 306 may be constructed of one or more suitable materials such as, for example, one or more of epoxy, plastic (e.g., thermoplastic), etc. In particular, the circuit board 306 is configured to communicatively couple to the vehicle 100 and/or one or more light sources of the lighting device 200 to facilitate and/or provide vehicle lighting functionality. For example, the circuit board 306 may be configured to control one or more lighting parameters associated with the light source(s) of the lighting device 200 such as, for example, one or more of an intensity, a color, a transition between light parameter(s), etc. Additionally, in examples where the lighting device 200 has beam aiming functionality, the circuit board 306 is configured to control a motor operatively coupled to a movable lighting component (e.g., a reflector), thereby changing a direction along which the light travels away from the lighting device 200.

The heatsink 302 of FIG. 3 includes a mounting surface or portion (e.g., an outer surface) 322 positioned near the seal 304 that is sized, shaped, structured, and/or otherwise configured to receive the circuit board 306. As shown in FIG. 3, the circuit board 306 is positioned on the mounting portion 322 and sufficiently held in place by the seal protrusion(s) 314, 316. Additionally, in some examples, the heatsink 302 includes one or more pegs or pins 324, 325 positioned on the mounting portion 322 to visually assist user(s) (e.g., vehicle servicer personnel) in properly positioning and/or orienting the circuit board 306 relative to the heatsink 302, two of which are shown in this example. In such examples, the circuit board 306 includes one or more recessed areas (e.g., curved area(s), circular area(s), semi-circular area(s), etc.) 326 positioned thereon (e.g., at or near an edge 328 of the circuit board 306) that extend around and/or otherwise receive respective ones of the pegs 324 when the circuit board 306 is installed.

FIG. 4 is an enlarged portion-view of the example heatsink assembly 300 of FIG. 3 and shows one of the protrusion(s) 314, 316 of the seal 304, which may be referred to as “the protrusion 314, 316” or “the single protrusion 314, 316” in connection with FIGS. 4-6. Thus, in some examples, aspects depicted in connection with the single protrusion 314, 316 likewise apply to one or more (e.g., all) other protrusions (e.g., one or more of the first protrusion 314, the second protrusion 316, etc.) of the seal 304. In particular, as previously mentioned, the protrusion 314, 316 of FIG. 3 is sized, shaped, structured, and/or otherwise configured to couple (e.g., removably couple) the circuit board 306 to the heatsink 302. In some examples, the protrusion 314, 316 includes one or more portions that is/are constructed of a flexible material (e.g., silicon), which allows the portion(s) of the protrusion 314, 316 to sufficiently flex, strain, bend, deform, compress, decompress, and/or otherwise move when the circuit board 306 is assembled with the heatsink 302. In some examples, the entire protrusion 314, 316 is flexible.

When the circuit board 306 is positioned on the mounting portion 322 of the heatsink 302, the protrusion 314, 316 imparts a force or pressure on the circuit board 306 to urge the circuit board 306 into engagement with the mounting portion 322, which maintains a position and/or an orientation of the circuit board 306 relative to the heatsink 302 such that the circuit board 306 is substantially prevented from separating from the heatsink 302. In some examples, the protrusion 314, 316 includes a first surface (e.g., an outer surface that is angled and/or curved) 402 that extends at least partially over and abuts a surface (e.g., outer surface) 404 of the circuit board 306, as shown in FIG. 4. In such examples, the surfaces 402, 404 form and/or define a first example angle (e.g., 5 degrees, 15 degrees, 30 degrees, etc.) 406. Further, in such examples, the first surface 402 extends beyond one of the sides 318, 320 of the circuit board 306 (i.e., extends over the circuit board surface 404) by a particular distance (e.g., 1 inch, 0.5 inches, 0.25 inches, etc.) 408. Additionally, in some examples, the protrusion 314, 316 includes a second surface (e.g., an outer surface that is angled and/or curved) 410 adjacent to the first surface 402 such that the first and second surfaces 402, 410 form an edge 412 of the protrusion 314, 316. In such examples, the first and second protrusion surfaces 402, 410 form and/or define a second example angle (e.g., 60 degrees, 70 degrees, 90 degrees, etc.) 413. In particular, the first and second surfaces 402, 410 are configured to receive one of the sides 318, 320 and/or an edge of the circuit board 306, for example, during and/or after installation of the circuit board 306. For example, when coupling the circuit board 306 to the heatsink 302 via the seal 302, a portion of the circuit board 302 slides from the second surface 410 to the first surface 402. Conversely, in examples, when decoupling the circuit board 306 from the heatsink 302, a portion of the circuit board 306 slides from the first surface 402 to the second surface 410.

In some examples, the protrusion 314, 316 includes a particular area 414 that is configured to strain and/or deform during installation of the circuit board 306, which is formed and/or defined by the first and second surfaces 402, 410 of the protrusion 314, 316 in this example. In particular, in such examples, as the circuit board 306 is pressed against the second surface 410 before reaching the mounting portion 322, the circuit board 306 causes the area 414 to compress, thereby allowing the circuit board 306 to reach the mounting portion 322. Then, in such examples, after the circuit board 306 reaches the mounting portion 322, the area 414 decompresses (e.g., partially decompresses), thereby causing the first surface 402 of the protrusion 314, 316 to abut the circuit board surface 404. In this manner, the protrusion 314, 316 maintains the engagement of the circuit board 306 and the heatsink 302 and/or otherwise maintains the position and/or orientation of the circuit board 306 relative to the heatsink 302.

Additionally or alternatively, in some examples, as the circuit board 306 is pressed against the second surface 410 before reaching the mounting portion 322, the circuit board 306 causes the protrusion 314, 316 to bend in a first direction (e.g., a horizontal direction) 416 away from the circuit board 306 and/or the mounting portion 322 by a first relatively small distance (e.g., 0.5 inches, 0.25 inches, 0.1 inches, etc.), thereby allowing the circuit board 306 to reach the mounting portion 322. Then, in such examples, after the circuit board 306 reaches the mounting portion 322, the protrusion 314, 316 bends in a second direction (e.g., a horizontal direction) 418 opposite the first direction 416 toward the circuit board 306 and/or the mounting portion 322 by a second relatively small distance (e.g., smaller than the first distance), thereby causing the first surface 402 of the protrusion 314, 316 to abut the circuit board surface 404. In this manner, the protrusion 314, 316 maintains the engagement of the circuit board 306 and the heatsink 302 and/or otherwise maintains the position and/or orientation of the circuit board 306 relative to the heatsink 302

As shown in FIG. 4, the circuit board 306 is interposed and/or coupled between the protrusion 314, 316 and the heatsink 302. That is, in some examples, the first surface 402 of the protrusion 314, 316 and the mounting portion 322 of the heatsink 302 squeeze the circuit board 306, which secures the circuit board 306.

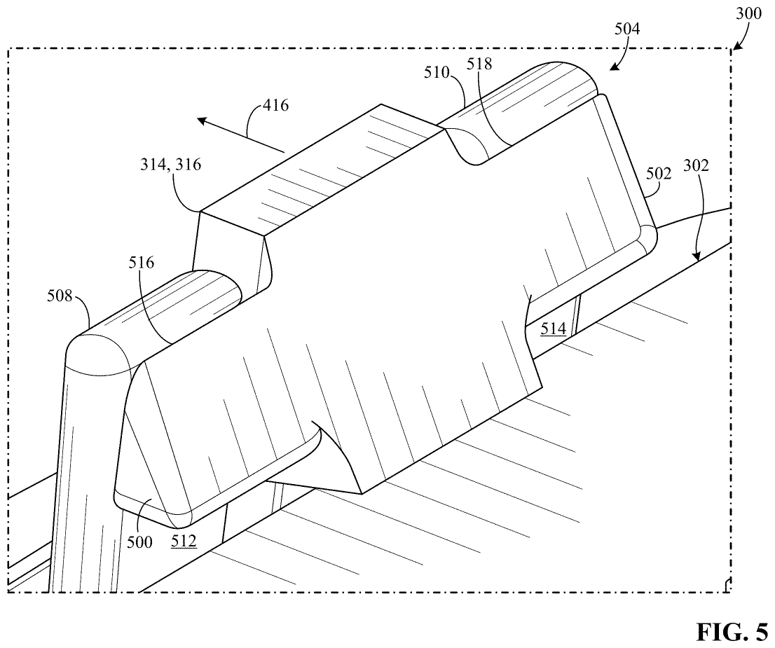

FIG. 5 is another enlarged portion-view of the example heatsink assembly 300 of FIG. 3 and shows a different view of the seal protrusion 314, 316. In some examples, to facilitate securing the circuit board 306 and/or otherwise fastening the circuit board 306 to the heatsink 302 via the seal 304, the protrusion 314, 316 includes one or more example arms 500, 502 coupled thereto and extending away from a central portion thereof (i.e., away from each other), two of which are shown in the illustrated example of FIG. 5 (i.e., a first arm 500 and a second arm 502). Further, in such examples, the heatsink 302 includes a first example abutment 504 coupled thereto that receives the arm(s) 500, 502. In particular, each of the arm(s) 500, 502 is sized, shaped, structured, and/or otherwise configured to engage the first abutment 504 when the circuit board 306 is positioned on the mounting portion 322, thereby preventing and/or limiting movement of the protrusion 314, 316 away from the circuit board 306 in the first direction 416 when the circuit board 306 is positioned on the mounting portion 322. As a result, the force or pressure imparted on the circuit board 306 by the protrusion 314, 316 is substantially maintained.

According to the illustrated example of FIG. 5, the first abutment 504 includes one or more protrusions 508, 510 extending away from the heatsink 302 past the circuit board 306, two of which are shown in this example (i.e., a third protrusion 508 and a fourth protrusion 510). The third and fourth protrusions 508, 510 are sometimes referred to as a first pair of protrusions. In such examples, the third and fourth protrusions 508, 510 define respective surfaces 512, 514, each of which is configured to engage a surface 516, 518 of a respective one of the arms 500, 502. As a result, each of the third and fourth protrusions 508, 510 imparts a force or pressure on the associated arm 500, 502, thereby maintaining the force or pressure imparted on the circuit board 306 by the protrusion 314, 316.

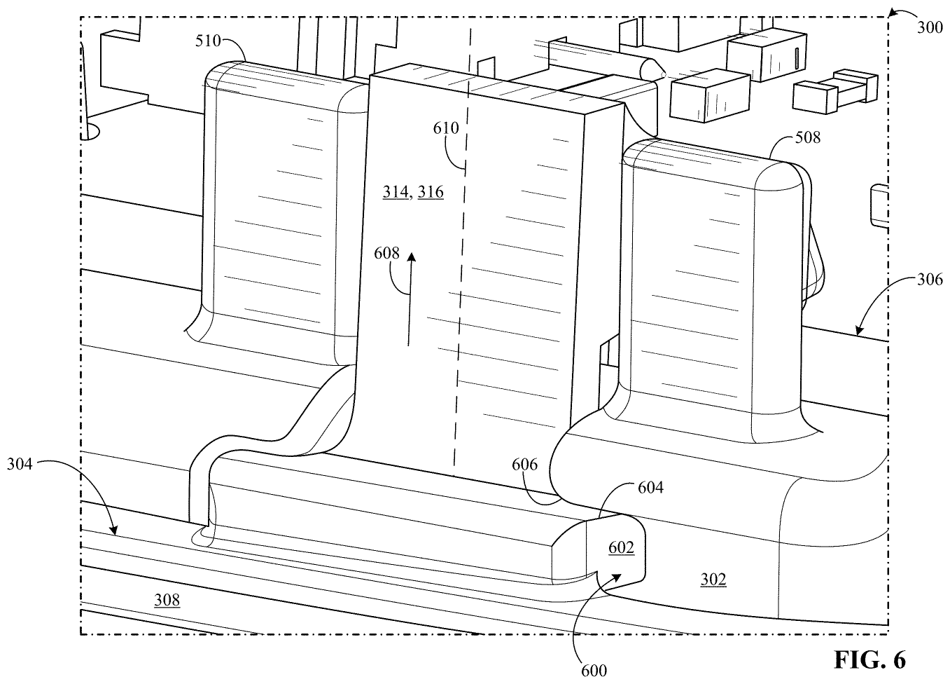

FIG. 6 is another enlarged portion-view of the example heatsink assembly 300 of FIG. 3 and shows a different view of the seal protrusion 314, 316. In some examples, to further facilitate securing the circuit board 306 and/or otherwise fastening the circuit board 306 to the heatsink 302 via the seal 304, the heatsink 302 includes a first example groove or slot 600 that extends at least partially into the heatsink 302 and is sized, shaped, structured, and/or otherwise configured to receive part of the seal 304. As shown in FIG. 6, the seal 304 includes an example tab 602 that extends into the first slot 600 and is interposed and/or coupled between the body 308 and the protrusion 314, 316. In particular, a surface (e.g., an outer or a topmost surface) 604 defined by the tab 602 engages one or more surfaces (e.g., inner surface(s)) 606 defined by the first slot 600, thereby preventing and/or limiting movement of the protrusion 314, 316 away from the circuit board 306 in a third direction (e.g., a vertical direction) 608 along an axis 610 of the protrusion 314, 316 when the circuit board 306 is positioned on the mounting portion 322. That is, the surface(s) 606 defined by the slot 600 impart a force or pressure on the tab surface 604. As a result, the force or pressure imparted on the circuit board 306 by the protrusion 314, 316 is substantially maintained.

Thus, the heatsink 302 may include one or more of the surfaces 512, 514, 606 to facilitate coupling functionality of the seal 304 by preventing and/or limiting movement of the seal protrusion 314, 316 away from the circuit board 306. In some examples, the first abutment 504 defines the outer surfaces 512, 514 of the heatsink 302 that abut the protrusion 314, 316. Further, in some examples, the first slot 600 defines the inner surface(s) 606 of the heatsink 302 that abut the protrusion 314, 316.

As shown in FIG. 6, the third and fourth protrusions 508, 510 extend along the axis 610 of the seal protrusion 314, 316. Additionally, the seal protrusion 314, 316 is positioned and/or extends between the pair of protrusions 508, 510.

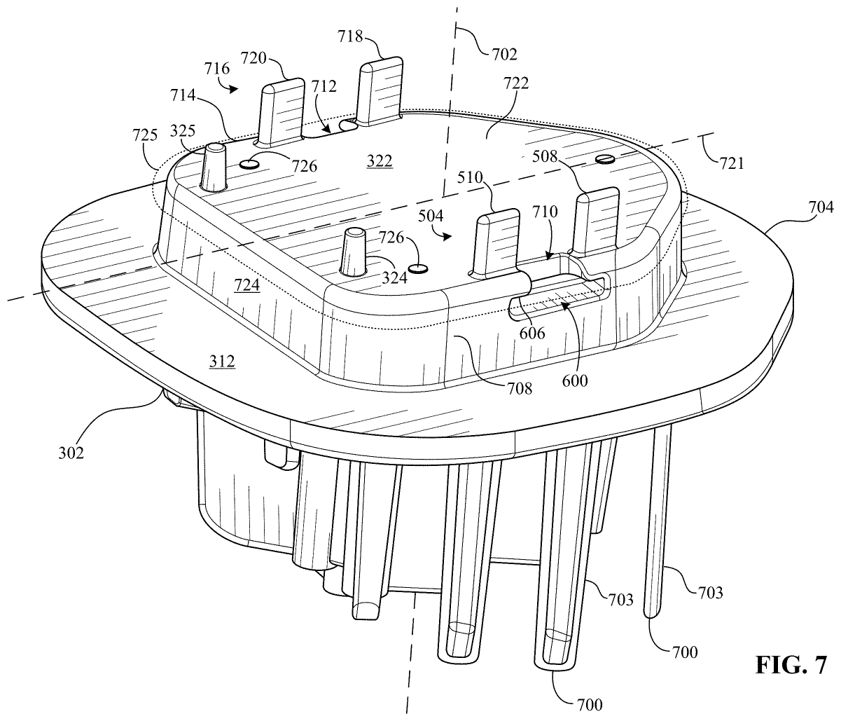

FIG. 7 is a detailed view of the heatsink 302 of the heatsink assembly 300 of FIG. 3. That is, for clarity, the heatsink 302 of FIG. 7 is separated from the seal 304 and the circuit board 306. As previously mentioned, the heatsink 302 is configured to dissipate heat generated by and/or otherwise existing in the lighting device 200. The heatsink 302 may be constructed of one or more materials having suitable mechanical properties such as, for example, one or more of aluminum, copper, plastic (e.g., thermoplastic), etc. In particular, the heatsink 302 of FIG. 7 includes one or more fins 700 coupled thereto that extend away from the mounting portion 322 along an axis 702 of the heatsink 302. Each of the fin(s) 700 defines a relatively large surface area 703, which facilitates transferring heat from the fin(s) 700 to the outside environment via one or more of convection heat transfer, conduction heat transfer, and/or radiation heat transfer.

In some examples, to facilitate mounting the heatsink 302 on the lighting device 200, the heatsink 302 includes an example flange 704 coupled thereto that at least partially surrounds the mounting portion 322 and extends radially outward relative to the axis 702. The flange 704 of FIG. 7 defines the heatsink surface 312, which is sized, shaped, structured, and/or otherwise configured to receive the portion (e.g., the housing 202) of the lighting device 200. Further, in some examples, the heatsink surface 312 is configured to receive and support the body 308 of the seal 304 (e.g., see FIG. 3).

As shown in FIG. 7, the first slot 600 is positioned on a first side 708 of the heatsink 302. In some examples, the first slot 600 includes a first recessed area 710 positioned on or near the mounting portion 322 to partially expose the surface(s) 606 defined by the first slot 600. That is, the recessed area 710 extends from the mounting portion 322 to the slot 600. In such examples, the first recessed area 710 receives the first seal protrusion 314 when the seal 304 is coupled to the heatsink 302. As shown in FIG. 7, the first recessed area 710 is interposed between the first pair of protrusions 508, 510. Additionally, in some examples, similar to the first slot 600, the heatsink 302 includes a second slot 712 positioned on a second side 714 of the heatsink 302, opposite the first side 708, that is configured to receive a portion (e.g., the tab 602) of the second seal protrusion 316 when the seal 304 is coupled to the heatsink 302. Thus, in some examples, the heatsink 302 is provided with a number (e.g., 1, 2, 3, etc.) of the slot(s) 600, 712 that is equal to a number of the seal protrusion(s) 314, 316 such that each of the slot(s) 600, 712 is associated with and/or receives a respective one of the seal protrusion(s) 314, 316.

As shown in FIG. 7, the first abutment 504 is positioned at or near the first side 708 of the heatsink 302 such that the first pair of protrusions 508, 510 is positioned on opposite sides of the first recessed 710. That is, the third and fourth protrusions 508, 510 are spaced from each other to allow a portion of the first seal protrusion 314 to be positioned therebetween. In some examples, the first abutment 504 is formed and/or defined by the heatsink 302. However, in some examples, the first abutment 504 is a component separate from the heatsink 302 and configured to couple thereto, for example, via one or more fasteners and/or fastening methods or techniques. Although FIG. 7 depicts the first abutment 504 having the two protrusions 508, 510, in some examples, the abutment 504 includes a single protrusion (e.g., a u-shaped protrusion) or more than two protrusions.

Additionally, in some examples, similar to the first abutment 504, the heatsink 302 includes a second example abutment 716 positioned near the second side 714 to prevent and/or limit movement of the second seal protrusion 316 away from the circuit board 306. In such examples, the second abutment 716 defines a second pair of protrusions 718, 720 (i.e., a fifth protrusion 718 and a sixth protrusion 720) that are configured to engage the arms 500, 502 of the second seal protrusion 316. Thus, in some examples, the heatsink 302 is provided with a number (e.g., 1, 2, 3, etc.) of the abutment(s) 504, 714 that is equal to a number of the seal protrusion(s) 314, 316 such that each of the abutment(s) 504, 714 is associated with and/or receives a respective one of the seal protrusion(s) 314, 316. According to the illustrated example of FIG. 7, the heatsink 302 includes a symmetry axis 721 whereby the first side 708 of the heatsink 302 is substantially similar or the same relative to the second side 714. That is, in such examples, the heatsink 302 is substantially symmetric about the symmetry axis 721. However, in other examples, the heatsink 302 is implemented differently (e.g., the first side 708 is shaped and/or sized different relative to the second side 714).

In some examples, the heatsink 302 includes a raised or central portion 722, which includes the mounting portion 322, that extends away from the flange 704 to elevate the mounting portion 322. In some such examples, the central portion 722 forms and/or defines a wall (e.g., a curved wall) 724 that receives the seal body 308 and has a first contour (e.g., a curved contour) 725 (as represented by the dotted/dashed line of FIG. 7). As such, when the seal 304 is coupled to the heatsink 302, the seal body 308 surrounds the wall 724 and substantially conforms to the first contour 725.

In some examples, to further facilitate mounting and/or securing the circuit board 306, the heatsink 302 includes one or more bosses 726 coupled thereto and extending away therefrom by a relatively small distance to receive the circuit board 306, three of which are shown in this example. In some examples, the heatsink 302 forms and/or defines the boss(es) 726. However, in other examples, the boss(es) 726 are components that are initially separate from the heatsink 302 and configured to couple to the heatsink 302, for example, via one or more fasteners and/or fastening methods or techniques. In any case, the mounting portion 322 is considered to include the boss(es) 726 in such examples.

In some examples, the peg(s) 324, 325 of the heatsink 302 abut respective sides and/or portions (e.g., surface(s) defined by respective ones of the recessed area(s) 326) of the circuit board 306 to prevent and/or limit movement of the circuit board 306. Although FIG. 7 depicts the heatsink 302 having the two pegs 324, 325, in some examples, the heatsink 302 is implemented differently (e.g., having a single peg or more than two pegs). In some examples where the seal 304 includes only one of the protrusion(s) 314, 316, the heatsink 302 includes an additional or third peg (not shown) such that the three heatsink pegs 324, 325 are configured to allow the circuit board 306 to move in only one direction (e.g., a horizontal direction) along the axis 721. In such examples, the single seal protrusion 314,316 is configured to prevent the circuit board 306 from moving in the one direction.

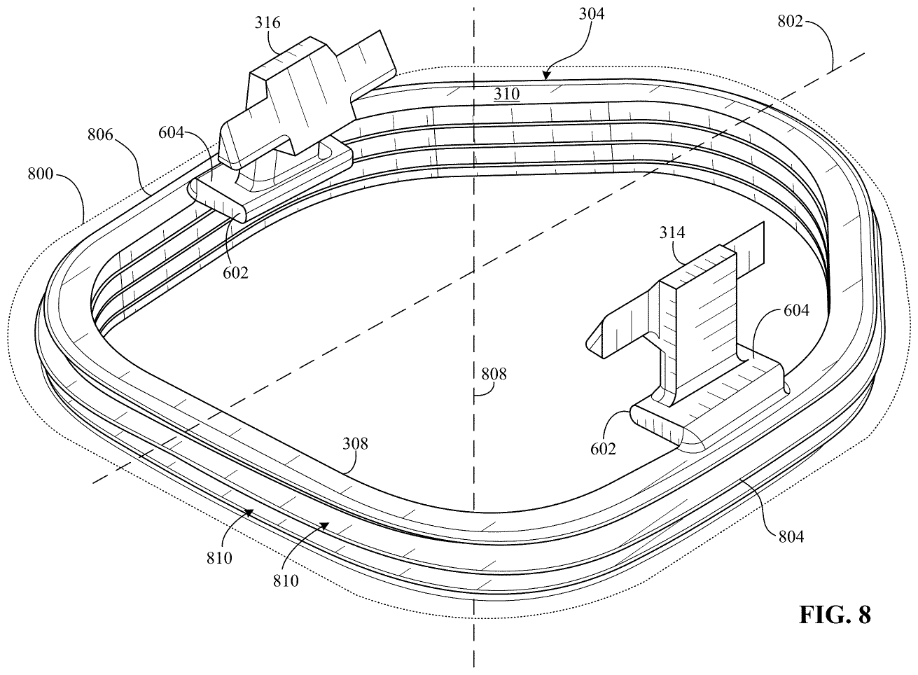

FIG. 8 is a detailed view of the seal 304 of the heatsink assembly 300 of FIG. 3. That is, for clarity, the seal 304 is separated from the heatsink 302 and the circuit board 306. The seal 304 and/or one or more of the components thereof may be constructed of one or more materials having suitable flexibility such as, for example, silicon. According to the illustrated example of FIG. 8, the body 308 of the seal 302 is sized, shaped, structured, and/or otherwise configured to match a size and/or shape of the flange surface 312 and/or the heatsink wall 724. In particular, the seal body 308 has a second contour (e.g., a curved contour) 800 (as represented by the dotted/dashed line of FIG. 8) that is substantially similar or the same relative to the first contour 725 of the heatsink wall 724. As shown in FIG. 8, the seal 304 is substantially symmetric about a symmetry axis 802 of the seal 304 whereby a first side 804 of the seal 304 is sized and/or shaped substantially similar or the same relative to a second side 806 of the seal 304. However, in some examples, the seal 304 is implemented differently (e.g., sized and/or shaped in a non-symmetric manner such that the first side 804 is different relative to the second side 806).

As shown in FIG. 8, the seal 304 includes the two protrusions 314, 316. Each of the seal protrusions 314, 316 includes the aforementioned tab 602 that extends toward a central axis 808 of the seal 304. In particular, each of the seal protrusion(s) 314, 316 is positioned on (e.g., centrally positioned on) and/or supported by a respective one of the tab surfaces 604 and extends away therefrom along the central axis 808. In examples where the seal 304 includes more than two of the seal protrusion(s) 314, 316, the seal protrusions 314, 316 are radially distributed on the body 308 relative to the central axis 808. As shown in FIG. 8, the two seal protrusions 314, 316 are substantially aligned to each other such that the seal protrusions 314, 316 are positioned on the same or a common axis.

In some examples, to facilitate sealing the lighting device 200 and/or otherwise improve sealing performance, the seal surface 310 forms and/or defines one or more example grooves 810 that are positioned on and extend along the seal body 308, which provide flexibility to the seal 304 and/or increase the flexibility thereof

In some examples, the seal 304 and/or the component(s) thereof is/are produced via injection molding. Thus, in some such examples, the seal body 308, the seal tab(s) 602, and the seal protrusion(s) 314, 316 are integral and/or otherwise form a single-piece component. Additionally, in some examples, the seal 304 and the components thereof are coupled to the heatsink 302 via injection molding. That is, in such examples, the seal 304 is molded over the heatsink 304. In other examples, the heatsink 304 and the seal 302 are formed separately and then coupled together, for example, by positioning the seal tab(s) 602 in the respective slot(s) 600 and/or using one or more fasteners and/or fastening methods or techniques (e.g., an adhesive).

Vehicle(s) and/or device(s) that include one or more of the features in the foregoing description provide numerous advantages. In particular, heatsink apparatus for use with vehicle lamps disclosed herein provide a heatsink for a vehicle lamp that easily couples to and/or decouples from a circuit board via a seal without additional fastener(s) and/or fastening methods, which reduces costs and/or production time associated with assembling (and/or disassembling) the heatsink and circuit board together.

Although certain example methods, apparatus, and articles of manufacture have been described herein, the scope of coverage of this patent is not limited thereto. On the contrary, this patent covers all methods, apparatus, and articles of manufacture fairly falling within the scope of the claims of this patent. Obviously, numerous modifications and variations are possible in light of the above teachings. It is therefore to be understood that within the scope of the appended claims, the invention may be practiced otherwise than as specifically described herein.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, defines, in part, the scope of the foregoing claim terminology such that no inventive subject matter is dedicated to the public.

1. A heatsink assembly of a vehicle lamp, comprising:
a circuit board;
a heatsink configured to couple to the vehicle lamp and defining a mounting portion to receive the circuit board; and
a seal coupled to the heatsink near the mounting portion and including a body configured to form a fluid seal between the heatsink and the vehicle lamp, the body of the seal including a clip that extends away therefrom past the mounting portion and is configured to couple the circuit board to the heatsink when the circuit board is positioned on the mounting portion,.
wherein:
the clip is configured to move in response to the circuit board moving past the clip toward the mounting portion, the clip to impart a force on the circuit board to urge the circuit board into engagement with the mounting portion,
the heatsink includes an abutment coupled thereto and extending away from the mounting portion to receive the clip, the abutment to impart a force on the clip to limit movement of the clip away from the circuit board,
the abutment includes first and second portions that are positioned on the heatsink proximate to the mounting portion and spaced from each other, the first and second portions to engage respective first and second arms of the clip that extend away from a central portion of the clip in opposite directions, and
the clip is at least partially positioned between the first and second portions of the abutment.

2. (canceled)

3. (canceled)

4. (canceled)

5. (canceled)

6. The heatsink assembly of claim 1, wherein the heatsink defines a slot in which a tab of the seal is positioned, the tab to engage an inner surface defined by the slot to limit movement of the clip away from the circuit board.

7. The heatsink assembly of claim 6, wherein the clip is positioned on the tab.

8. The heatsink assembly of claim 1, wherein the clip includes two angled surfaces that form an edge and are configured to receive a side of the circuit board.

9. The heatsink assembly of claim 8, wherein the clip includes an area formed by the two angled surfaces that is configured to compress and decompress in response to the circuit board contacting the area.

10. The heatsink assembly of claim 1, wherein the clip is a first clip and the body of the seal includes a second clip extending away therefrom and configured to couple the circuit board to the heatsink, wherein the first and second clips are positioned on opposite sides of the circuit board.

11. The heatsink assembly of claim 10, wherein the first and second clips include a flexible material.

12. A motor vehicle lamp, comprising:
a heatsink coupled to a housing of the motor vehicle lamp and defining one or more fins to transfer heat away from the motor vehicle lamp;
a circuit board positioned on the heatsink; and
a seal defining a body interposed between the heatsink and the housing to prevent fluid from leaking into or out of the housing, the seal including a first protrusion that is positioned on the body and extends over the circuit board, the first protrusion urging the circuit board into engagement with the heatsink,.
wherein:
the first protrusion of the seal abuts one or more surfaces of the heatsink to maintain a force that the first protrusion imparts on the circuit board, and
the heatsink includes second and third protrusions positioned proximate to and extending along an axis of the first protrusion, the second and third protrusions defining the one or more surfaces of the heatsink.

13. (canceled)

14. (canceled)

15. The motor vehicle lamp of claim 12, wherein the first protrusion of the seal defines first and second portions extending away from each other, each of the second and third protrusions of the heatsink to impart a force on a respective one of the first and second portions of the first protrusion.

16. The motor vehicle lamp of claim 12, wherein the first protrusion of the seal is positioned between the second and third protrusions of the heatsink.

17. The motor vehicle lamp of claim 12, wherein a portion of the first protrusion extends into a slot positioned on a wall of the heatsink, the slot defining the one or more surfaces of the heatsink.

18. The motor vehicle lamp of claim 17, wherein the heatsink includes a recessed area extending from an outer surface of the heatsink to the slot to expose a portion of the slot, the first protrusion positioned in the recessed area.

19. The motor vehicle lamp of claim 12, wherein the body of the seal surrounds a curved wall of the heatsink.

20. A motor vehicle, comprising:
a heatsink coupled to a lamp of the motor vehicle and including a circuit board positioned thereon; and
a seal coupled to the heatsink and interposed between a surface of the lamp and a surface of the heatsink to seal a cavity of the lamp, the seal including first and second means for coupling the circuit board to the heatsink, wherein the first and second means for coupling the circuit board to the heatsink are positioned on opposite sides of the circuit board.
